(19) United States
(12) Patent Application Publication
(10) Pub. No.: US 2023/0113280 A1
(43) Pub. Date: Apr. 13, 2023

(54) COLOUR-STRONG MANGANESE FERRITE COLOUR PIGMENTS

(71) Applicant: LANXESS Deutschland GmbH, Cologne (DE)

(72) Inventors: Carsten Rosenhahn, Kempen (DE); Uwe Hempelmann, Meerbusch (DE)

(73) Assignee: LANXESS Deutschland GmbH, Cologne (DE)

(21) Appl. No.: 17/913,240

(22) PCT Filed: Mar. 12, 2021
(86) PCT No.: PCT/EP2021/056356

§ 371 Date: Sep. 21, 2022

(30) Foreign Application Priority Data
Mar. 27, 2020 (EP) 20166327.5

(51) Int. Cl. C01G 49/00; C09C 1/24

(52) U.S. Cl. CPC C01G 49/0072; C09C 1/24; C01P 2002/54

(57) ABSTRACT

The present invention relates to strongly coloured manganese ferrite colour pigments, to the production thereof and to the use thereof.

The present invention relates to strongly coloured manganese ferrite colour pigments, to the production thereof and to the use thereof.

Manganese ferrites of the general composition Mn₁₊ₓFe₂₋ₓO₄[x=−0.8 to +0.8] are temperature-resistant up to more than 1000° C., and are suitable in particular for incorporation into materials that are subject to heat curing. Iron oxide black pigments based on Fe₃O₄ cannot be used for such fields of application because this oxide is known to be oxidized to brown or red Fe₂O₃ above approx. 200° C.

Some temperature-stable black pigments are already known from the patent literature. For example, U.S. Pat. No. 2,811,463 A1 describes a product having Cu oxide, Mn oxide and Fe oxide as the main constituents, and U.S. Pat. No. 3,201,270 A1 describes a black pigment having Co3O₄, Cr2O₃ and Fe₃O₄ as the main constituents. However, these pigments contain copper and cobalt, which is undesirable for customers. In addition, copper and cobalt are heavy metals and can adversely affect the environment.

Known from DE 1 191 063 A1, furthermore, is a process for producing a temperature-resistant iron oxide black pigment containing, besides iron oxide, about 7% to 20% manganese oxide. However, this pigment has two major drawbacks: it has an undesirable reddish hue and a relatively low colour strength. The so-called red tinge is often disadvantageously noticeable both in the concentrated state of the pigment and when blended. A reddish grey, rather than a neutral grey, is obtained with a white extender (for example titanium dioxide or barium sulfate). The low colour strength necessitates the use of a relatively great amount of the pigment in order to reach a specific shade of grey. This relatively great amount of pigment can adversely affect important properties of the pigmented material, such as the strength.

DE 1 767 868 A1 therefore discloses that manganese ferrites produced from a relatively finely divided starting paste exhibit an improved colour strength with respect to the prior art at the time.

These pigments were able to increase the colour strength of the pigments to about three times the prior art, and have remained the measure of things to this day. DE 1 767 868 A1 also describes that mineralizers can reduce the calcining temperature required to generate the desired pigments.

DE 3 304 635 A1 describes that the calcining can also be performed with pelletized mixtures.

The drawback of all the pigments listed in the abovementioned prior art remains that the colour strength of pigments based on manganese ferrite is too low in comparison to colour pigments based on Fe₃O₄.

The subsequent developments for generating improved manganese ferrite colour pigments, which are described in DE 3 841 313 A1 and DE 4 003 255 A1, involve the production in the wet phase from soluble salts and by precipitation with sodium hydroxide solution. These pigments are ecologically objectionable due to the high consumption of sodium hydroxide solution and can only be produced very uneconomically.

The object of the present invention was therefore to provide improved, strongly coloured manganese ferrite colour pigments that preferably also exhibit temperature stability and that are able to be produced in an environmentally friendly manner without sodium hydroxide solution.

This object was achieved by a manganese ferrite black pigment having a content of MnO of 5.0% to 40.0% by weight and a content of phosphate of 1.5% to 3.0% by weight, that has a blending ratio for the depth of shade value B 1/9 in accordance with DIN 53235 Part 1 and 2 of >−12.0, in particular >−10.0.

The manganese ferrite black pigment preferably has a content of MnO of 8.0% to 35.0% by weight.

The manganese ferrite black pigment preferably has a content of phosphate of 1.5% to 2.0% by weight, more preferably of 1.7% to 1.8% by weight.

Very particularly preferably, the manganese ferrite black pigment has a blending ratio for the depth of shade value B 1/9 in accordance with DIN 53235 Part 1 and 2 of −10.0 to −6.0.

The colour strength of the manganese ferrite black pigments is preferably from 40% to 120% stronger, more preferably from 90% to 115% stronger, with respect to manganese ferrite colour pigments that have a phosphate content of <0.5%.

The methods for measuring the blending ratio for the depth of shade value B 1/9 and the colour strength are specified in the examples.

The invention also encompasses a process for producing a manganese ferrite black pigment, characterized in that
oxidic or oxide-forming starting materials of the iron and manganese are mixed with one another with addition of alkali metal salts and organic and/or inorganic phosphates, and
the mixture is then calcined at temperatures above 600° C., preferably above 700° C., where the calcining atmosphere has an oxygen content of 7% to 25%.

Preferably, the content of MnO is from 5% to 40% by weight, more preferably from 8.0% to 35.0% by weight; the content of Fe, calculated as Fe₂O₃, is from 50.0% to 95.0% by weight, more preferably from 65.0% to 90.0% by weight; and the content of phosphate is from 1.5% to 3.0% by weight, more preferably from 1.5% to 2.0% by weight, where the sum total of MnO, Fe₂O₃ and phosphate must not be above 100% by weight.

Phosphate sources used may be all common alkali metal or alkaline earth metal phosphates, di-, tri-, tetra-, oligo- or polyphosphates, and all other known organic or inorganic phosphates. Furthermore, use may be made of phosphoric acid, phosphinic acid, phosphonic acid, and the diphosphorus analogues thereof and the salts thereof. It makes no difference here whether the phosphates are primary, secondary or tertiary phosphates. The water solubility, the vitrification state or the condensation state (for example metaphosphates) of the phosphates also makes no difference to the process if the mixing of the particles is sufficient.

The invention also encompasses the use of the manganese ferrite black pigment for the colouring of inorganic or organic dispersions, of products of the paint, lacquer, coating, building materials, plastics and paper industries, in food, and in products of the pharmaceutical industry such as tablets. Care must be taken here to comply with the legally permitted contents of heavy metals.

The inventive subject matter of the present invention is given not only by the subject matter of the individual claims but also by the combination of the individual claims with one another. The same applies to all parameters disclosed in the description and to any desired combinations thereof.

The examples that follow elucidate the invention in more detail, without any intention that they should limit the invention.

### EXAMPLES

I. Description of the Measurement Methods Used

A. Determination of the Iron Content and Manganese Content

The iron content and the manganese content were measured by acid digestion and potentiometric titration. An introduction to electrochemical analysis methods—which also include potentiometric titration—can be found by way of example in “Taschenatlas der Analytik”, G. Schwedt, Thieme-Verlag 1996, ISBN 3-527-30870-9 p. 50 ff. The measurement method has a determination accuracy of 0.2% by weight.

B. Measurement of the Colour Values in L64Thix, Lightening

The pigment was prepared using a muller in a non-drying test binder. The test binder (paste) is composed of two components:

Component 1

SACOLYD® L640 (Krems Chemie AG, Austria, alkyd resin binder based on linseed oil and phthalic anhydride) (formerly ALKYDAL® L64 (Bayer AG, DE)). It corresponds to the specifications given in standards DIN EN ISO 787-24 (October 1995), ISO 787-25:1993 and DIN 55983 (December 1983) as requirements for a test binder for colour pigments.

Component 2

LUVOTHIX® HT (Lehmann & Voss & Co., Germany, pulverulent, modified, hydrogenated castor oil) as rheological additive which is added for the thixotroping of the paste. It was used in a concentration of 5.0% by weight, based on Component 1.

Component 2 was dissolved in Component 1 at 75-95° C. The cooled, compact mass was passed once through a triple-roll mill. The L64 paste was then complete. Use was made of a plate-type paint dispersing machine (muller), as described in DIN EN ISO 8780-5 (April 1995). Used was an ENGELSMANN JEL 25/53 muller with an effective plate diameter of 24 cm. The speed of the lower plate was approx. 75 min⁻¹. The force between the plates was set at approx. 0.5 kN by hanging a 2.5 kg loading weight on the loading bracket.

The lightener used was a commercial titanium dioxide pigment, TRONOX® R-KB-2, Kerr-McGee Corp., US (formerly BAYERTITAN® R-KB-2 (Bayer AG, DE)). The composition of R-KB-2 corresponds to type R 2 in ISO 591-1977. 0.4 g of pigment to be tested, 2.0 g of TRONOX® R-KB-2 and 3.0 g of paste were dispersed in five stages of 25 revolutions each by the process described in DIN EN ISO 8780-5 (April 1995) Section 8.1.

The pigment/paste mixture was then spread into a paste plate, the function of which corresponds to the paste plate in DIN 55983 (December 1983). The doctor blade belonging to the paste plate is drawn over the indentation in the plate that is filled with the pigment/paste mixture, so that a smooth surface is produced. This doctor blade is moved in one direction at a speed of approx. 3-7 cm/s. The smooth surface is measured within a few minutes.

C. Colorimeter

A spectrophotometer (“colorimeter”) having the d/8 measurement geometry without a gloss trap was used. This measurement geometry is described in ISO 7724/2-1984 (E), Section 4.1.1, in DIN 5033 Part 7 (July 1983), Section 3.2.4 and in DIN 53236 (January 1983), Section 7.1.1.

Used was a DATAFLASH® 2000 measuring device (Datacolor International Corp., USA). The colorimeter was calibrated against a white, ceramic working standard, as described in ISO 7724/2-1984 (E) Section 8.3. The reflection data of the working standard against an ideally matt-white body are stored in the colorimeter so that, after calibration with the white working standard, all colour measurements are related to the ideally matt-white body. The black-point calibration was carried out using a black hollow body from the manufacturer of the colorimeter.

D. Colour Measurement

The result of the colour measurement is a reflection spectrum. It is possible to calculate any desired colorimetric parameter from the reflection spectrum. The colorimetric parameters used in this case are calculated in accordance with DIN 6174 (CIELAB values).

Any gloss trap present is switched off. The temperature of the colorimeter and test specimen was approx. 25° C.±5° C.

E. Colour Strength

The colour values are stated according to the above-described measurement in accordance with DIN 6174 (CIELAB values). The relative colour strength of the measured colour pigment in relation to a comparative pigment (in the given case: comparative pigment) also results from the measurement in the lightening. The comparative pigment has a colour strength of 100%.

In order to state an absolute characteristic value from these relative figures, the so-called “blending ratio” was calculated. The blending ratio was determined in accordance with DIN standard 53235 Part 1 and Part 2 from 1974 for the depth of shade value B 1/9. The blending ratio illustratively indicates the ratio of a colour-imparting substance to a mixing component (in the given case: TiO₂) which is used to achieve a defined depth of shade (depth of colour) in accordance with DIN standard 53235 Part 1 and 2 from 1974. A high blending ratio means that the same depth of colour can be achieved using less pigment. Such a pigment therefore has a stronger colour in practical use. A blending ratio for the depth of shade value B 1/9 in accordance with DIN 53235 Part 1 and 2 of greater than −10 corresponds to a colour strength that is at least 45% higher than the comparative pigment.

F. Other Devices

The stirring unit used was an Ultraturrax stirrer.

Suitable calcining apparatuses are common furnaces (for example muffle furnace, rotary flame furnace, rotary furnaces etc.) as long as the oxygen content in the calcining space is from 5% to 25%.

Suitable grinding units are all common comminution units for inorganic pigments, such as vibratory disc mills, classifier mills or jet mills.

### II. Example 1

The properties of the starting materials iron oxide (Fe₃O₄), manganese oxide (MnO₂) and sodium chloride correspond to the requirements from DE 1 767 868 A1 Example 1.

321.5 g of an Fe₃O₄ suspension having a content of 31.1% by weight of Fe, calculated as Fe₂O₃, are admixed with 14 g of manganese(IV) oxide (manganese content: 67.3% by weight, calculated as MnO), 2.3 g of sodium chloride and 2.8 g of sodium tripolyphosphate, intimately mixed using a suitable stirring unit and filtered off with suction on a suction filter, the filter cake is dried at 240° C., homogenized in a mortar and then calcined at 800° C. for 15 minutes, homogenized again in a mortar and calcined at 800° C. for a further 25 minutes. The resulting pigment is then ground in a suitable device.

The pigment formed has a colour strength of 146% in relation to the comparative pigment. The blending ratio for depth of shade value B 1/9 is −9.7.

In contrast, the pigment in Comparative Example 1, which was calcined without being doped with phosphate, only has a colour strength of 75% in relation to the comparative pigment, which corresponds to a blending ratio of −17.2.

### III. Example 2

The properties of the starting materials iron oxide (Fe₃O₄), manganese oxide (MnO₂) and sodium chloride correspond to the requirements from DE 1 767 868 A1 Example 1.

321.5 g of an Fe₃O₄ suspension having a content of 31.1% by weight of Fe, calculated as Fe₂O₃, are admixed with 22 g of manganese(IV) oxide (manganese content: 67.3% by weight, calculated as MnO), 2.3 g of sodium chloride and 3.0 g of sodium tripolyphosphate, intimately mixed using a suitable stirring unit and filtered off with suction on a suction filter, the filter cake is dried at 240° C., homogenized in a mortar and then calcined at 800° C. for 15 minutes, homogenized again in a mortar and calcined at 800° C. for a further 25 minutes. The resulting pigment was then ground in a suitable device.

The pigment formed has a colour strength of 168% in relation to the comparative pigment. The blending ratio for depth of shade value B 1/9 is −8.0.

In contrast, the pigment in Comparative Example 2, which was calcined without being doped with phosphate, only has a colour strength of 79% in relation to the comparative pigment, which corresponds to a blending ratio of −16.5.

### IV. Example 3

The properties of the starting materials iron oxide (Fe₃O₄), manganese oxide (MnO₂) and sodium chloride correspond to the requirements from DE 1 767 868 A1 Example 1.

321.5 g of an Fe₃O₄ suspension having a content of 31.1% by weight of Fe, calculated as Fe₂O₃, are admixed with 31 g of manganese(IV) oxide (manganese content: 67.3% by weight, calculated as MnO), 2.3 g of sodium chloride and 3.1 g of sodium tripolyphosphate, intimately mixed using a suitable stirring unit and filtered off with suction on a suction filter, the filter cake is dried at 240° C., homogenized in a mortar and then calcined at 800° C. for 15 minutes, homogenized again in a mortar and calcined at 800° C. for a further 25 minutes. The resulting pigment was then ground in a suitable device.

The pigment formed has a colour strength of 177% in relation to the comparative pigment. The blending ratio for depth of shade value B 1/9 is −7.3.

In contrast, the pigment in Comparative Example 3, which was calcined without being doped with phosphate, only has a colour strength of 86% in relation to the comparative pigment, which corresponds to a blending ratio of −15.6.

### V. Example 4

The properties of the starting materials iron oxide (Fe₃O₄), manganese oxide (MnO₂) and sodium chloride correspond to the requirements from DE 1 767 868 A1 Example 1.

321.5 g of an Fe₃O₄ suspension having a content of 31.1% by weight of Fe, calculated as Fe₂O₃, are admixed with 41.5 g of manganese(IV) oxide (manganese content: 67.3% by weight, calculated as MnO), 2.3 g of sodium chloride and 3.3 g of sodium tripolyphosphate, intimately mixed using a suitable stirring unit and filtered off with suction on a suction filter, the filter cake is dried at 240° C., homogenized in a mortar and then calcined at 800° C. for 15 minutes, homogenized again in a mortar and calcined at 800° C. for a further 25 minutes. The resulting pigment was then ground in a suitable device.

The pigment formed has a colour strength of 184% in relation to the comparative pigment. The blending ratio for depth of shade value B 1/9 is −6.7.

In contrast, the pigment in Comparative Example 4, which was calcined without being doped with phosphate, only has a colour strength of 88% in relation to the comparative pigment, which corresponds to a blending ratio of −15.3.

### VI. Example 5

The properties of the starting materials iron oxide (Fe₃O₄), manganese oxide (MnO₂) and sodium chloride correspond to the requirements from DE 1 767 868 A1 Example 1.

161 g of an Fe₃₀₄ suspension having a content of 31.1% by weight of Fe, calculated as Fe₂O₃, are admixed with 38.0 g of manganese(IV) oxide (manganese content: 67.3% by weight, calculated as MnO), 1.5 g of sodium chloride and 2.0 g of sodium tripolyphosphate, intimately mixed using a suitable stirring unit and filtered off with suction on a suction filter, the filter cake is dried at 240° C., homogenized in a mortar and then calcined at 800° C. for 15 minutes, homogenized again in a mortar and calcined at 800° C. for a further 25 minutes. The resulting pigment was then ground in a suitable device.

The pigment formed has a colour strength of 167% in relation to the comparative pigment. The blending ratio for depth of shade value B 1/9 is −7.7.

VII. Comparative Pigment

The properties of the starting materials iron oxide (Fe₃O₄), manganese oxide (MnO₂) and sodium chloride correspond to the requirements from DE 1 767 868 A1 Example 1.

161 g of an Fe₃₀₄ suspension having a content of 31.1% by weight of Fe, calculated as Fe₂O₃, are admixed with 38 g of manganese(IV) oxide (manganese content: 67.3% by weight, calculated as MnO), 1.5 g of sodium chloride and without sodium tripolyphosphate, intimately mixed using a suitable stirring unit and filtered off with suction on a suction filter, the filter cake is dried at 240° C., homogenized in a mortar and then calcined at 800° C. for 15 minutes, homogenized again in a mortar and calcined at 800° C. for a further 25 minutes. The resulting pigment was then ground in a suitable device.

The pigment formed is used as comparative pigment for the examples described above. Its colour strength is set at 100%. The blending ratio for depth of shade value B 1/9 is −14.0.

TABLE 1

| | % by | % by | % by | Colour | Blending |
|---|---|---|---|---|---|
| | weight | weight | weight | strength | ratio |
| Example | Fe | Mn | PO₄ | in % | B 1/9 |
| 1 | 89.81 | 8.46 | 1.73 | 146 | −9.7 |
| C 1 | 91.39 | 8.61 | — | 75 | −17.2 |
| 2 | 85.57 | 12.67 | 1.76 | 168 | −8.0 |
| C 2 | 87.11 | 12.89 | — | 79 | −16.5 |
| 3 | 81.30 | 16.96 | 1.73 | 177 | −7.3 |
| C 3 | 82.74 | 17.26 | — | 86 | −15.6 |
| 4 | 76.80 | 21.45 | 1.74 | 184 | −6.7 |
| C 4 | 78.16 | 21.84 | — | 88 | −15.3 |
| 5 | 65.01 | 33.12 | 1.79 | 167 | −7.7 |
| Comparative | 66.20 | 33.80 | — | 100 | −14.0 |
| pigment | | | | | |

TABLE 2

| | | | | | Increase |
|---|---|---|---|---|---|
| | | | | | in colour |
| | | | | | strength with |
| | | | | | respect to |
| | % by | % by | % by | Colour | comparative |
| | weight | weight | weight | strength | example |
| Example | Fe | Mn | PO₄ | in % | in % |
| 1 | 89.81 | 8.46 | 1.73 | 146 | 94.7 |
| C 1 | 91.39 | 8.61 | — | 75 | |
| 2 | 85.57 | 12.67 | 1.76 | 168 | 112.7 |
| C 2 | 87.11 | 12.89 | — | 79 | |
| 3 | 81.30 | 16.96 | 1.73 | 177 | 105.8 |
| C 3 | 82.74 | 17.26 | — | 86 | |
| 4 | 76.80 | 21.45 | 1.74 | 184 | 109.1 |
| C 4 | 78.16 | 21.84 | — | 88 | |

1. Manganese ferrite black pigments having a content of MnO of 5.0% to 40.0% by weight and a content of phosphate of 1.5% to 3.0% by weight, that have a blending ratio for the depth of shade value B 1/9 in accordance with DIN 53235 Part 1 and 2 of >−12.0.

2. The manganese ferrite black pigments according to claim 1, wherein the pigments have a content of MnO of 8.0% to 35.0% by weight.

3. The manganese ferrite black pigments according to claim 1, wherein the pigments have a content of phosphate of 1.5% to 2.0% by weight.

4. The manganese ferrite black pigments according to claim 1, wherein the pigments have a blending ratio for the depth of shade value B 1/9 in accordance with DIN 53235 Part 1 and 2 of −10.0 to −6.0.

5. The manganese ferrite black pigments according to claim 1, wherein the colour strength of the pigments is from 40% to 120% stronger with respect to manganese ferrite colour pigments that have a phosphate content of <0.5%.

6. Process for producing a manganese ferrite black pigment according to claim 1, wherein
oxidic or oxide-forming starting materials of the iron and manganese are mixed with one another with addition of alkali metal salts and organic and/or inorganic phosphates, and
the mixture is then calcined at temperatures above 600° C. where the calcining atmosphere has an oxygen content of 7% to 25%.

7. Process for producing a manganese ferrite black pigment according to claim 6, wherein
the content of MnO is from 5% to 40% by weight;
the content of Fe, calculated as Fe₂O₃, is from 50.0% to 95.0% by weight; and
the content of phosphate is from 1.5% to 3.0% by weight,
where the sum total of MnO, Fe₂O₃ and phosphate must not be above 100% by weight.

8. Process for the colouring of inorganic or organic dispersions, of products of the paint, lacquer, coating, building materials, plastics and paper industries, in food, and in products of the pharmaceutical industry such as tablets, wherein the manganese ferrite black pigments according to claim 1 are utilized.

9. The manganese ferrite black pigments according to claim 1, wherein the blending ratio for the depth of shade value B 1/9 in accordance with DIN 53235 Part 1 and 2 is >−10.0.

10. The manganese ferrite black pigments according to claim 1, wherein the pigments have a content of phosphate of 1.7% to 1.8% by weight.

11. The manganese ferrite black pigments according to claim 1, wherein the colour strength of the pigments is from 90% to 115% stronger, with respect to manganese ferrite colour pigments that have a phosphate content of <0.5%.

12. The process according to claim 6 for producing a manganese ferrite black pigment according to claim 1, wherein
oxidic or oxide-forming starting materials of the iron and manganese are mixed with one another with addition of alkali metal salts and organic and/or inorganic phosphates, and
the mixture is then calcined at temperatures above 700° C., where the calcining atmosphere has an oxygen content of 7% to 25%.

13. The process according to claim 7 for producing a manganese ferrite black pigment according to claim 6, wherein
the content of MnO is from 8.0% to 35.0% by weight;
the content of Fe, calculated as Fe₂O₃, is from 65.0% to 90.0% by weight; and
the content of phosphate is from 1.5% to 2.0% by weight,
where the sum total of MnO, Fe₂O₃ and phosphate must not be above 100% by weight.
